(19) United States
(12) Patent Application Publication
(10) Pub. No.: US 2016/0332289 A1
(43) Pub. Date: Nov. 17, 2016

(54) HEAD STRUCTURE OF A PNEUMATIC TOOL

(71) Applicant: MASTER AIR TOOL CO., LTD., Taichung City (TW)

(72) Inventor: Nan-Hsin WANG, Taichung (TW)

(21) Appl. No.: 15/221,137

(22) Filed: Jul. 27, 2016

Related U.S. Application Data
(63) Continuation-in-part of application No. 13/658,532, filed on Oct. 23, 2012, now abandoned.

(30) Foreign Application Priority Data
Feb. 10, 2012 (TW) 101104394

(51) Int. Cl. B25F 5/00; B24B 47/12; B24B 23/02

(52) U.S. Cl. CPC B25F 5/001; B24B 23/026; B24B 47/12

(57) ABSTRACT

A head structure of a pneumatic tool has an accommodation room in a pneumatic tool body. A driving gear and a transmission unit are pivoted in the accommodation room. The transmission unit includes a gear member having a transmission gear to mesh with the driving gear. The rear end of the gear member is provided with a gear rod. A bearing fitted on the gear rod is limited to a first limit portion at the distal end of the transmission gear. The gear rod is connected with a connection member having a second connection portion to engage with the first connection portion. The connection member has a second limit portion adapted to limit another side of the bearing. The limit member is secured to the distal end of the accommodation room and adapted to limit the bearing in the accommodation room.

### BACKGROUND OF THE INVENTION

1. Field of the Invention The present invention relates to a head structure of a pneumatic tool.

2. Description of the Prior Art

FIG. 1 is an exploded view of a head of a conventional pneumatic tool. A pneumatic tool body 10 comprises a gear (not shown) which is located in a front end of a housing 12. A transmission unit 20 is installed in the housing 12. The transmission unit 20 comprises a transmission rod 21, a gear 22 and a bearing 23. The transmission rod 21 has a slot 211 on a side wall thereof. The transmission rod 21 has a connection portion 212 extending out of the housing 12. The bearing 23 is sleeved on the transmission rod 21, and the gear 22 is assembled at a distal end of the transmission rod 21. The gear 22 has a slot 221 on an inner wall thereof. A pin 24 is provided between the slot 211 of the transmission rod 21 so that the gear 22 will be secured on the transmission rod 21. The gear 22 will be driven by a driving means installed in the pneumatic tool body 10 so as to drive and rotate the transmission rod 21. When the transmission unit 20 is assembled, the transmission rod 21 and the gear 22 are securely connected. Because the assembly of the pneumatic tool is difficult, the housing 12 shall be relatively large in its volume and also it needs a large space for the assembly of the tool. When the transmission unit 20 is driven to turn, there will be a gap between the slots 211 having the key 24 installed therein and the connection portion 221. Because of the gap, the transmission rod 21 will collide with the gear 22 to generate a noise during usage of the tool and even damage the associated parts easily.

### SUMMARY OF THE INVENTION

It is therefore the main object of the present invention is to provide a head structure of a pneumatic tool with a close connected moving parts therein so that to avoid the noise during usage and has a smooth rotation without the possibility to cause damage of the relative moving parts in the head structure of a pneumatic tool

Another object of the present invention is to provide a head structure of a pneumatic tool which can be easily assembled and relatively smaller in size.

A principal feature of the present invention of a head structure of a pneumatic tool comprises a limit member in the transmission unit to tightly secure the gears in the transmission unit.

Therefore in summary, a head structure of a pneumatic tool according to the present invention comprises a body having an accommodation room at a front end thereof, a driving gear and a transmission unit which are pivotally connected in the accommodation room. The transmission unit comprises a gear member, a connection member and a bearing. The gear member comprises a transmission gear at one end thereof relative to the driving gear. The transmission gear has a first limit portion at a rear end thereof. The rear end of the first limit portion is provided with a gear rod. The gear rod has a first connection portion at a distal end thereof. A bearing is sleeved on the gear rod. One side of the bearing is limited to the first limit portion. The connection member has a second connection portion. The second connection portion is engaged with the first connection portion. The connection member has a second limit portion. The second limit portion is adapted to limit another side of the bearing. The limit member has a central through hole. The limit member is secured to a distal end of the accommodation room. The limit member is adapted to limit the bearing in the accommodation room. Through the gear member and the connection member to limit the bearing, the connection is easy and there is no gap. The space occupied by the parts can be reduced so as to reduce the size of the accommodation room.

### BRIEF DESCRIPTION OF THE DRAWINGS

Those and other advantages, objects and features of the head structure of a pneumatic tool according to the present invention will become apparent from the below detail description of the invention with reference to the accompanying drawings, wherein:

FIG. 1 is an exploded view of a conventional pneumatic tool head;

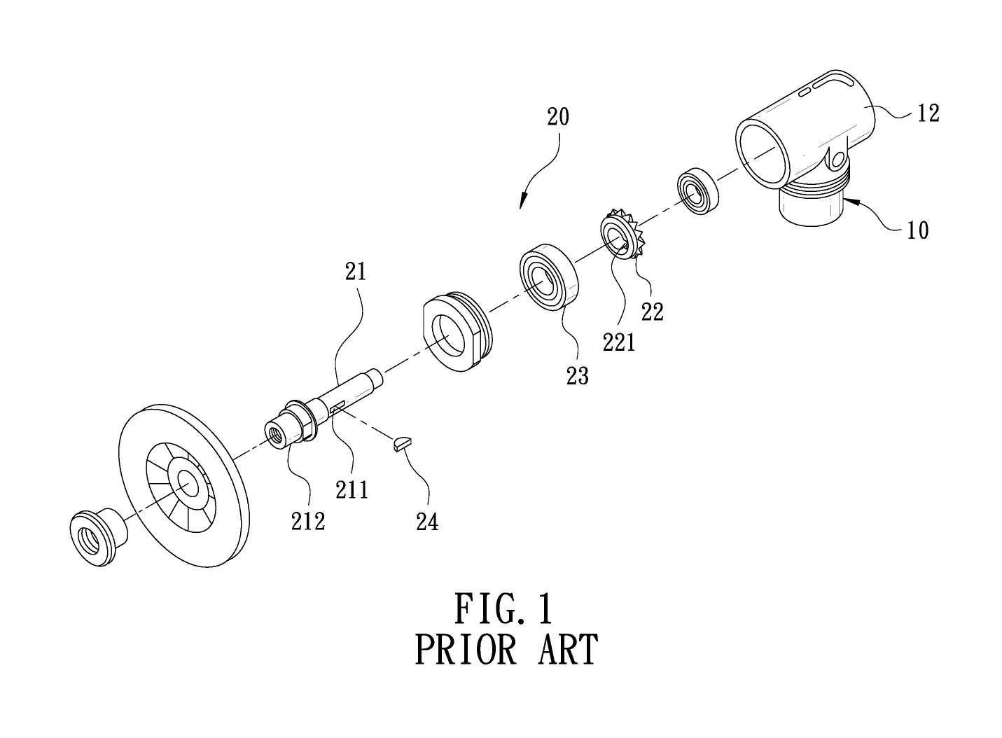

FIG. 2 is an exploded view of a head structure of a pneumatic tool according to a first embodiment of the present invention;

FIG. 3 is a sectional view of a head structure of a pneumatic tool according to a first embodiment of the present invention;

FIG. 4 is a sectional view of a head structure of a pneumatic tool according to a second embodiment of the present invention;

FIG. 5 is a sectional view of a head structure of a pneumatic tool according to a third embodiment of the present invention; and

FIG. 6 is a sectional view of a head structure of a pneumatic tool according to a fourth embodiment of the present invention.

### DETAILED DESCRIPTION OF THE PREFERRED EMBODIMENTS

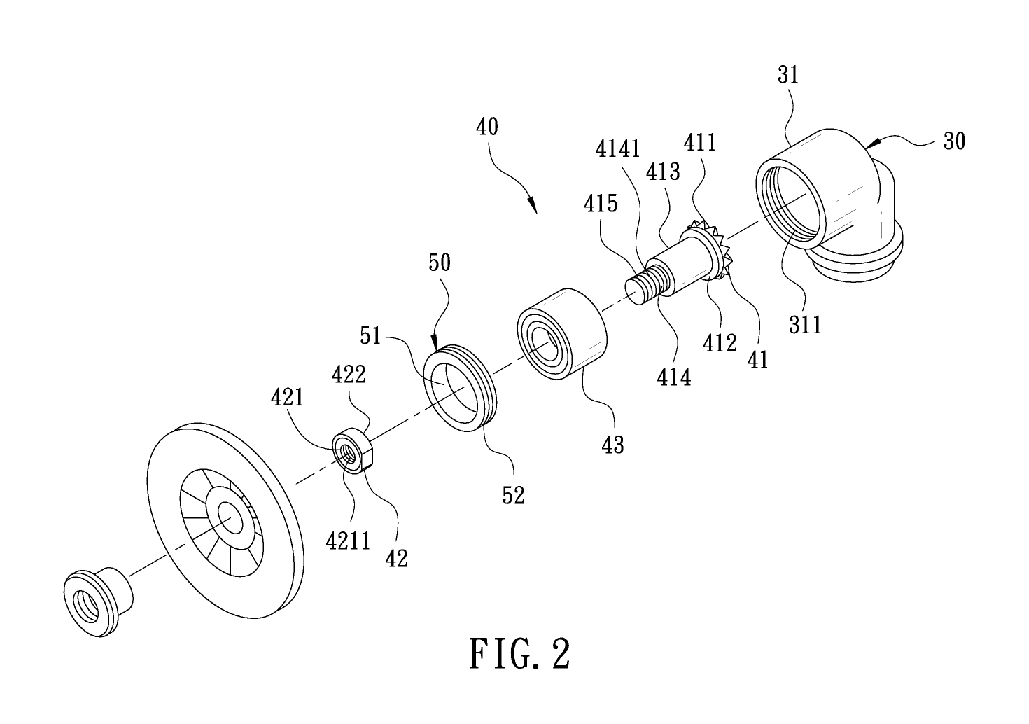

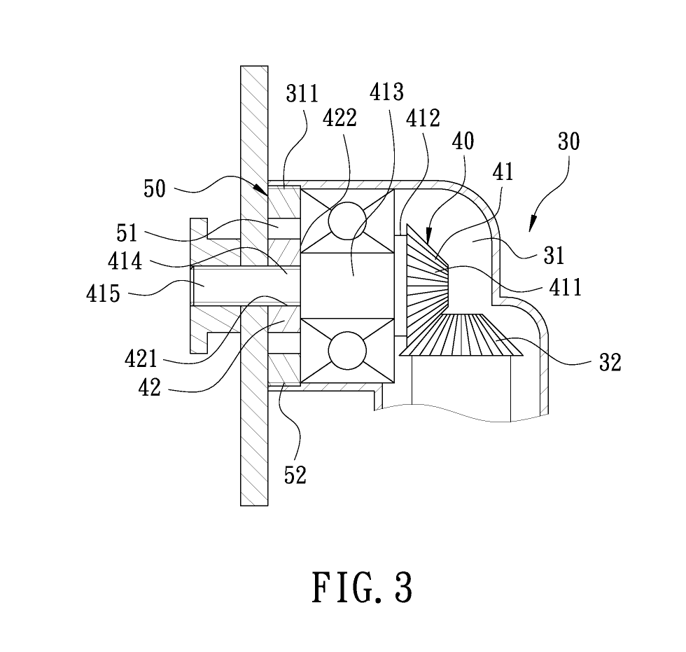

Referring to FIG. 2 and FIG. 3 which are exploded view and sectional view of a head structure of a pneumatic tool according to a first embodiment of the present invention, the pneumatic tool of the present invention comprises a pneumatic tool body 30, a transmission unit 40, and a limit member 50.

The pneumatic tool body 30 has an accommodation room 31 at a front end thereof. The accommodation room 31 has inner threads 311 on a distal end thereof. The pneumatic tool body 30 comprises a driving gear 32 which is pivotally connected in the accommodation room 31. The pneumatic tool may be a pneumatic grinder or a pneumatic polisher.

The transmission unit 40 is pivotally connected in the accommodation room 31. The transmission unit 40 comprises a gear member 41, a connection member 42 and a bearing 43. The gear member 41 comprises a transmission gear 411 at one end thereof relative to the driving gear 32. The transmission gear 411 has a first limit portion 412 at a rear end thereof. The rear end of the first limit portion 412 is provided with a gear rod 413. The gear rod 413 has a first connection portion 414 at a distal end thereof. The first connection portion 414 is outer threads 4141. The first connection portion 414 has a connection rod 415 at a distal end thereof. The bearing 43 is fitted on the gear rod 413. One side of the bearing 43 is limited to the first limit portion 412. The connection member 42 has a second connection portion 421. The second connection portion 421 of the connection member 42 is a threaded trough 4211. The threaded trough 4211 is engaged with the outer threads 4141. One side of the connection member 42 has a second limit portion 422. The first limit portion 412 and the second limit portion 422 are adapted to limit the bearing 43.

The limit member 50 has a central through hole 51 for the insertion of the connection rod 415. The limit member 50 has outer threads 52 on an outer wall thereof. The outer threads 52 are engaged with the inner threads 311 of the accommodation room 31, so that the limit member 50 is secured to the distant end of the accommodation room 31. The limit member 50 is adapted to limit the bearing 43 at a predetermined position in the accommodation room 31.

Still referring to FIG. 2 and FIG. 3, when the transmission unit 40 is assembled, the connection member 42 is first screwed to the gear member 41 and the bearing 43 is secured. The limit member 50 presses the bearing 43 to limit the bearing 43 at a predetermined position in the accommodation room 31. The driving gear 32 drives the transmission gear 411 to turn the connection rod 415 so as to bring rotation of the tool. This assembly simply uses the gear member 41 and the connection member 42 to be connected with each other. The connection is simple and exact to enhance the precision of the connection. The transmission gear 411 of the gear member 41 and the gear rod 413 are integral. Therefore there is no gap there between to generate noise or to damage the related parts while rotation. Also the number of related rotation parts in the accommodation room 31 is reduced.

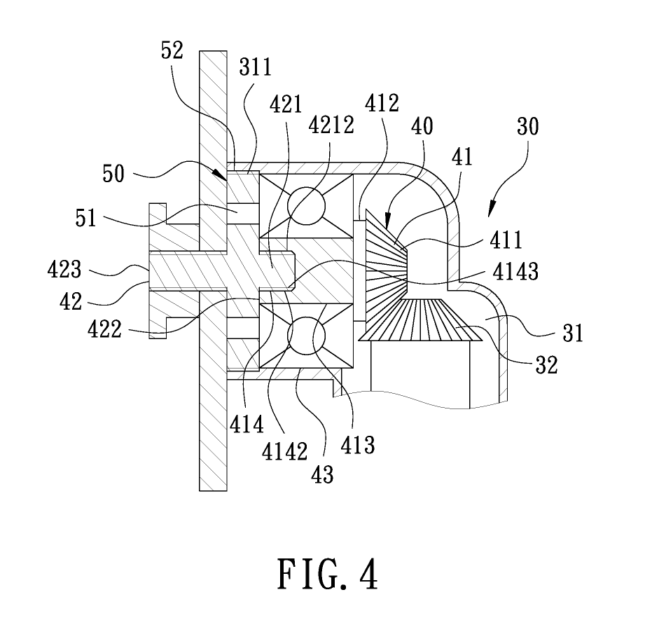

FIG. 4 is a sectional view of a head structure of a pneumatic tool according to a second embodiment of the present invention, which is substantially similar to the first embodiment with the exception described hereinafter. The first connection portion 414 is a trough 4142 formed at the distal end of the gear rod 413. The trough 4142 has inner threads 4143. The second connection portion 421 is a threaded rod 4212. The threaded rod 4212 of the second connection portion 421 is screwed to the inner threads 4143 of the trough 4142 of the first connection portion 414. The connection member 42 has a connection rod 423 at another side opposite to the second connection portion 421. The connection rod 423 is adapted to connect the tool.

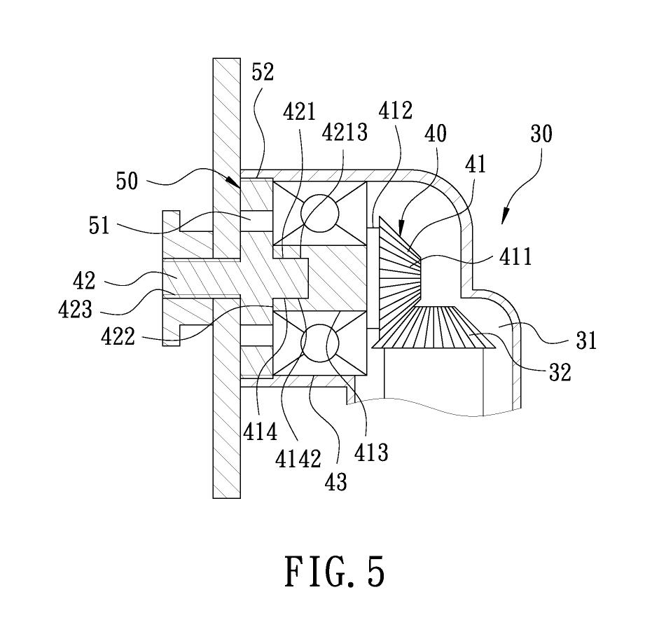

FIG. 5 is a sectional view of a head structure of a pneumatic tool according to a third embodiment of the present invention, which is substantially similar to the first embodiment with the exception described hereinafter. The first connection portion 414 is a trough 4142. The second connection portion 421 is a tightening rod 4213 corresponding to the trough 414. The diameter of the tightening rod 4213 is greater than the diameter of the trough 4142. The tightening rod 4123 is forced to engage with the trough 4142. The connection member 42 has a connection rod 423 at another side opposite to the second connection portion 421. The connection rod 423 is inserted through the through hole 51 and exposed out of the accommodation room 31.

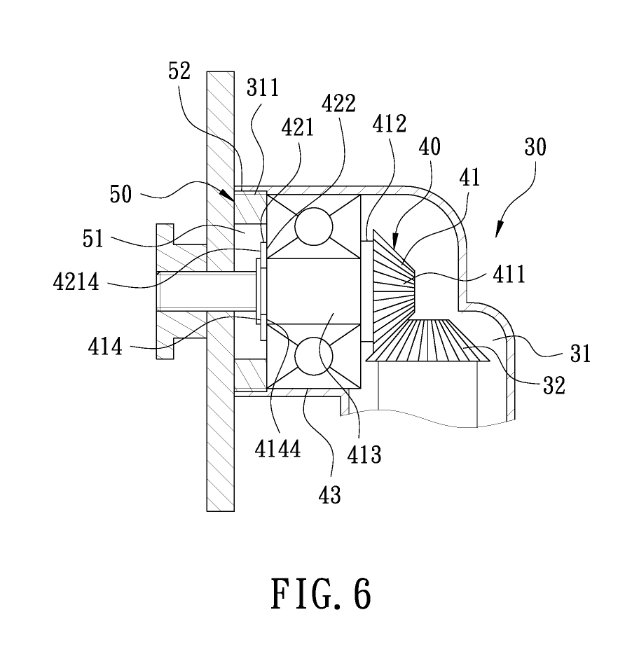

FIG. 6 is a sectional view of a head structure of a pneumatic tool according to a fourth embodiment of the present invention, which is substantially similar to the first embodiment with the exception described hereinafter. The first connection portion 414 is an annular groove 4144 formed at the distal end of the gear rod 413. The second connection portion 421 is a C-shaped buckle 4214. When the connection member 42 is fitted on the gear rod 413, the C-shaped buckle 4214 is confined in the annular groove 4144, so that the connection member 42 is confined on the gear rod 413. The distal end of the gear rod 413 is provided with a connection rod 415. The connection rod 415 is inserted through the through hole 51 and exposed out of the accommodation room 31.

Although particular embodiments of the present invention have been described in detail for purposes of illustration, various changes, improvements and modifications can still be made without departing from the spirit and scope of the claims of the present invention.

What is claimed is:

1. A head structure of a pneumatic tool, comprising:
a pneumatic tool body having an accommodation room at a front end thereof, said pneumatic tool body comprising a driving gear which being pivotally connected in said accommodation room;
a transmission unit being pivotally connected in said accommodation room, said transmission unit comprising a gear member, a connection member and a bearing, said gear member comprising a transmission gear at one end thereof relative to said driving gear, said transmission gear having a first limit portion at a rear end thereof, a gear rod with a rear end thereof formed against said first limit portion of said transmission gear, said gear rod having a first connection portion at a distal end thereof, said bearing being fitted on said gear rod, one side of said bearing being limited by said first limit portion, said connection member having a second connection portion which being connected with said first connection portion, said connection member having a second limit portion which being adapted to limit another side of said bearing; and
a limit member having a central through hole, said limit member being secured to a distal end of said accommodation room and being adapted to limit said bearing in said accommodation room.

2. A head structure of a pneumatic tool as claimed in claim 1, wherein said first connection portion is a trough having inner threads, said second connection portion being a threaded rod relative to said trough, said threaded rod being screwed to said trough, said connection member having a connection rod at another side opposite to said second connection portion, said connection rod being inserted through a through hole and extending out of said accommodation room.

3. A head structure of a pneumatic tool as claimed in claim 1, wherein said first connection portion is outer threads formed at the distal end of said gear rod, said second connection portion of the connection member being a trough with threads which being engaged with said outer threads, a distal end of said gear rod being provided with a connection rod being inserted through the through hole and extending out of said accommodation room.

4. A head structure of a pneumatic tool as claimed in claim 1, wherein said first connection portion is a trough, said second connection portion being a tightening rod corresponding to said trough, said tightening rod being forced to engage with said trough, said connection member having a connection rod at another side opposite to said second connection portion, said connection rod being inserted through the through hole and extending out of said accommodation room.

5. A head structure of a pneumatic tool as claimed in claim 1, wherein said first connection portion is an annular groove formed at a distal end of said gear rod, said second connection portion being a C-shaped buckle which being confined in said annular groove when said connection member is fitted on said gear rod, the distal end of said gear rod being provided with a connection rod which being inserted through the through hole and extending out of the accommodation room.

6. A head structure of a pneumatic tool as claimed in claim 1, wherein said accommodation room has inner threads on a distal end thereof, said limit member having outer threads on an outer wall thereof, said limit member being screwed to the distal end of said accommodation room.
